(19) United States
(12) Patent Application Publication
(10) Pub. No.: US 2024/0088491 A1
(43) Pub. Date: Mar. 14, 2024

(54) INTEGRALLY FORMED TERMINAL STRUCTURE FOR BATTERY CELL

(71) Applicant: Rivian IP Holdings, LLC, Plymouth, MI (US)

(72) Inventors: Prajanya Sunil Kendrekar, San Jose, CA (US); Ki Woon Kim, Milpitas, CA (US); Susheel Teja Gogineni, Sunnyvale, CA (US)

(21) Appl. No.: 17/931,586

(22) Filed: Sep. 13, 2022

(51) Int. Cl. H01M 50/148; H01M 50/188

(52) U.S. Cl. CPC H01M 50/154; H01M 50/188

(57) ABSTRACT

At least one aspect is directed to a battery cell. The battery cell can include a current collector having a wall that defines an opening. The wall can have a surface from a first planar surface of the current collector to a second planar surface of the current collector. The battery cell can have a lid having a protrusion. The protrusion can have a surface, the surface of the protrusion coupled with the surface of the wall.

### INTRODUCTION

Vehicles such as electric vehicles can be powered by batteries. Operation of the vehicle can use power and deplete the batteries.

### SUMMARY

This technical solution is directed to a battery cell cathode terminal with integrable protrusion structures. The cathode terminal can include a plurality of components, including two or more of a current collector, a lid, and a terminal. The current collector can couple with the lid by a protrusion in lid having a shape corresponding to an opening in the current collector. One or more of the opening and the protrusion can be formed by a stamping process to form those structures with one or a reduced number of mechanical operations per component. The current collector can include an opening that extends through the current collector to reduce the energy required to bond the lid to the current collector at the protrusion. A technical advantage of a current collector structure including an opening can include reducing or eliminating cutting of material to expose an interface between the current collector and the protrusion of the lid. The terminal can be coupled with the lid at a surface of the lid opposite to the current collector, to sandwich the lid between the current collector and the terminal. The lid can be formed by stamping process to include a structure corresponding to the current collector and to include the protrusion, for example. The cathode terminal can include a current collector coupled to a component having a lid and an integrated terminal structure, reducing the number of mechanical components required to fabricate a structure and the number of operations required to assemble the cathode terminal.

At least one aspect is directed to a battery cell. The battery cell can include a current collector having a wall that defines an opening. The wall can have a surface from a first planar surface of the current collector to a second planar surface of the current collector 110. The battery cell can have a lid having a protrusion. The protrusion can have a surface, the surface of the protrusion coupled with the surface of the wall.

At least one aspect is directed to a method. The method can include forming a current collector having a wall, the wall having a surface from a first planar surface of the current collector to a second planar surface of the current collector. The method can include forming a lid having a protrusion, the protrusion having a surface, the surface of the protrusion coupled with the surface of the wall.

At least one aspect is directed to an electric vehicle. The electric vehicle can include a battery cell can include a current collector having a wall, the wall having a surface from a first planar surface of the current collector to a second planar surface of the current collector. The electric vehicle can a lid having a protrusion, the protrusion having a surface, the surface of the protrusion coupled with the surface of the wall.

At least one aspect is directed to a method. The method can include providing a battery cell with a current collector having a wall that defines an opening, the wall having a surface from a first planar surface of the current collector to a second planar surface of the current collector. The method can include providing a battery cell with a lid having a protrusion, the protrusion having a surface, the surface of the protrusion coupled with the surface of the wall.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example three-dimensional view of a cathode terminal.

FIG. 2 depicts an example cross-sectional view of a cathode terminal.

FIG. 3 depicts an example three-dimensional view of a cathode terminal.

FIG. 4 depicts an example cross-sectional view of a cathode terminal.

FIG. 5 depicts an example three-dimensional view of a cathode terminal.

FIG. 6 depicts an example cross-sectional view of a cathode terminal.

FIG. 7 depicts an example three-dimensional view of a cathode terminal.

FIG. 8 depicts an example cross-sectional view of a cathode terminal.

FIG. 9 depicts an example electric vehicle.

FIG. 10 depicts an example battery pack.

FIG. 11 depicts an example battery module.

FIG. 12A depicts an example cross sectional view of a battery cell.

FIG. 12B depicts an example cross sectional view of a battery cell.

FIG. 12C depicts an example cross sectional view of a battery cell.

FIG. 13 depicts an example method of forming a battery cell cathode terminal.

FIG. 14 depicts an example method of forming a battery cell cathode terminal.

### DETAILED DESCRIPTION

Following below are more detailed descriptions of various concepts related to, and implementations of, methods, apparatuses, and systems of a cathode terminal with integrable protrusion structures for a battery cell. The various concepts introduced above and discussed in greater detail below may be implemented in any of numerous ways.

This technical solution is generally directed to a battery cell cathode terminal. The battery cell cathode terminal can have a three-part structure or a two-part structure. The technical solution demonstrates a technical improvement of higher integrity of a battery cell cathode due to a contact between two or more portions of the battery cell cathode having mateable structures. The battery cell cathode can include a current collector component and a lid component. The current collector component can include a cavity formed at least partially through the current collector in a planar surface of the current collector component. The lid component can include a protrusion extending from a planar surface of the lid and having a shape corresponding to or matching a shape of the cavity of the current collector component. The current collector component and the lid component can be integrated with one another by disposing the lid component over the current collector component with the protrusion of the lid disposed within the cavity and in contact with a sloping portion of the current collector forming a sidewall of the cavity within the current collector component. The protrusion can fill the cavity to form a flush surface by a planar surface of the protrusion with a planar surface of the current collector component.

The current collector component can be integrated with the lid component by bonding the protrusion to the sloping portion at one or more points. The welding of the current collector with the lid by the protrusions through a cavity extending (e.g., completely) though the current collector can provide a technical improvement. A technical improvement can include reducing energy to complete a weld by eliminating a cut-through or weld operation through a portion of the current collector covering the protrusion and the sloping portion. The welding of the current collector with the lid by the protrusions through a cavity extending partially though the current collector can provide a technical improvement. A technical improvement can include reducing energy to complete a weld by reducing to a minimum distance a cut-through or weld operation through a portion of the current collector covering the protrusion and the sloping portion.

The lid component can include a lip portion at a periphery along a planar surface of the lid component. The lip portion can include a portion of the surface of the lid component disposed at least partially surrounding the protrusion. The lip portion can, for example, be pressed into the lid component at a first planar surface corresponding to a top of the lid component. The protrusion can be further pressed into the lid component within an area surrounded by the lip portion. The lip portion can be formed to mate with a terminal component having a planar structure and a shape corresponding to or matching a shape of the lip portion. For example, the terminal component can be disposed in contact with the lip portion of the lid component. The lid component can thus be disposed in contact with and between the current collector component and the terminal component.

The lid component can include a terminal protrusion extending in a direction opposite to the protrusion mateable with the current collector component. The lid component can include the terminal protrusion extending with a shape corresponding to the terminal component. For example, the lid component having the terminal protrusion can comprise a two-part battery cell terminal including the lid component integrated with a terminal portion, and the current collector component. The two-part battery cell can achieve a technical improvement of reducing the number of components required to assemble a battery cell terminal, and reduce the complexity of integrating the parts by eliminating the welds to integrate the lid component with the terminal component. The battery cell can achieve a technical improvement of eliminating a requirement of a sealing process to create a seal over a hole, cavity, or the like, in the lid. The seal can introduce a mechanical or electrical point of failure, and eliminating a required sealing operation can provide a technical improvement of increasing mechanical or electrical lifespan, broadening operating environment conditions, or any combination thereof. One or more of the terminal component, the lid component, and the current collector component can include a flat planar surface. For example, the current collector component can include a flat surface mateable with a first flat surface of the lid component. The terminal component can include a flat surface mateable with a second flat surface of the lid component opposite to the first flat surface of the lid component. Thus, the lid component can be disposed in contact with and between the current collector component and the terminal component. This configuration can result in the technical improvement of simplifying machining of parts to create a battery cell terminal.

This technical solution can be housed at least partially within or at least partially integrated with an enclosure. For example, an enclosure can correspond to the lid component, or a portion of the lid component. For example, the lid component can be a portion enclosure or a subset of an enclosure having a plurality of enclosure member. For example, enclosure members can include one or more members of a structure corresponding to a can, a cap, a faceplate, a ring, or any portion or combination thereof. For example, enclosure members can include one or more of a five-sided structure at least partially surrounding a cavity, a one-sided planar structure, and a tubular structure at least partially surrounding a cavity. An enclosure can be compatible with a cell-to-pack structural battery structure.

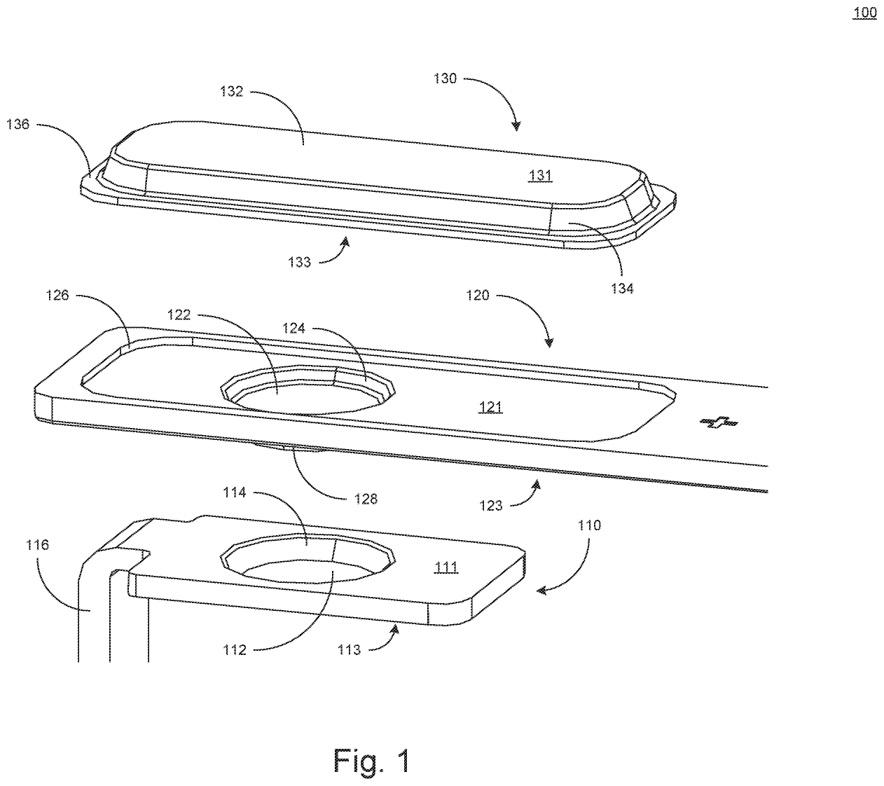

FIG. 1 depicts an example three-dimensional view of a cathode terminal 100. As illustrated by way of example in FIG. 1, an exploded view of a cathode terminal 100 can include a current collector 110, a lid 120, and a terminal 130.

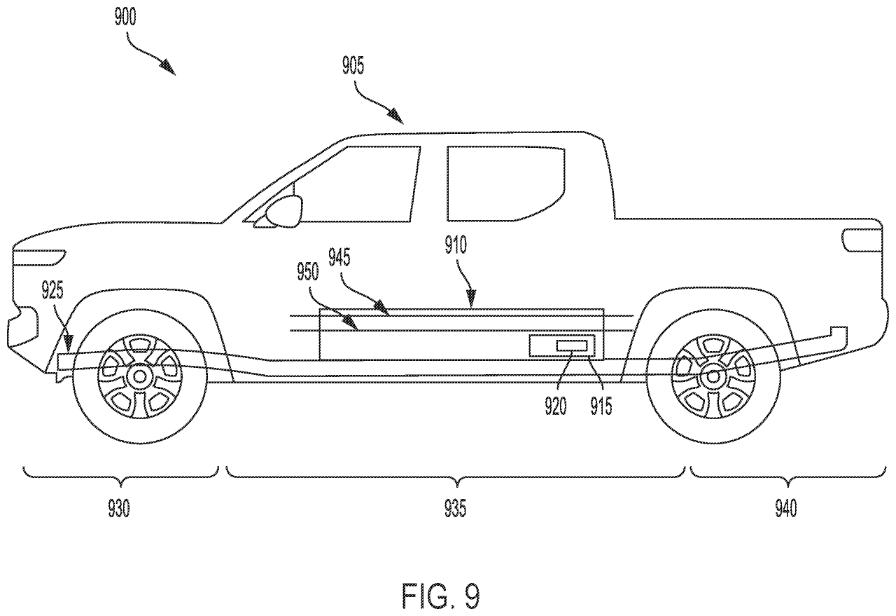

The current collector 110 can include a metallic structure to transmit electrical current to or from a battery cell (e.g., battery cell 920 as in FIG. 9, among others). The current collector 110 can be operatively coupled with and physically attached or integrated with a battery cell. The current collector 110 can have a planar or substantially planar structure that can couple with the lid 120. The current collector 110 can include a top surface 111, an opening 112, a bottom surface 113, a wall 114, and a body 116. The top surface 111 can be disposed facing away from a direction in which the body 116 extends, and can contact the lid 120. The bottom surface 113 can be disposed facing toward a direction in which the body 116 extends, and can correspond to a surface of the current collector 110 opposite to the top surface 111.

The opening 112 can define a void in the current collector 110, and can extend partially or completely through the current collector 110 at a structure bounded by the top surface 111 and the bottom surface 113. For example, the opening 112 can extend from the top surface 111 to the bottom surface 113 to form a hole partially or completely through the current collector 110 between the top surface 111 and the bottom surface 113. The opening can take have a shape in a plan view corresponding to any two-dimensional shape projectable onto the top surface 111 or the bottom surface 113 of the current collector 110. The battery cell can include the wall defining the opening that projects at least one of a circular, oval, polygonal, square, and rectangular shape from the first planar surface of the current collector. For example, the opening 112 can have a shape in a plan view corresponding to a circle or ellipse.

The wall 114 can include a surface of the current collector 110, and can at least partially surround the opening 112. The wall 114 can be oriented perpendicular or substantially perpendicular to one or more of the top surface 111 and the bottom surface 113. The wall 114 can be oriented at an angle with one or more of the top surface 111 and the bottom surface 113, to form a slope of the wall 114. The battery cell can include the sloped surface of the wall oriented at an angle from the first planar surface of the current collector and extending around the opening in the current collector between the first planar surface and the second planar surface of the current collector. A slope of the wall 114 can result in a portion of the opening 112 coplanar with the top surface 111 to have a size different than a portion of the opening 112 coplanar with the bottom surface 113. For example, the opening 112 can have a shape in a plan view at the top surface 111 corresponding to a circle having a first diameter. The opening 112 can have a shape in a plan view at the bottom surface 113 corresponding to a circle having a second diameter less than the first diameter. For example, a sloped surface can include a surface at any angle between and including parallel to one or more of the of the top surface 111 and the bottom surface 113, and perpendicular to one or more of the of the top surface 111 and the bottom surface 113.

The body 116 can include a portion of the current collector 110 that can couple with a battery cell. For example, the body can couple with the battery cell by a bolting, screwing, weld, rivet, conductive adhesive bond, any bond as discussed herein, or any combination thereof. The body 116 can include a substantially planar structure that can couple with the battery cell. The top surface 111 and the bottom surface 113 of the current collector 110 can be substantially orthogonal to the substantially planar structure of the body 116. For example, the body 116 can form an “L” shape with the portion of the current collector corresponding to the top surface 111 and the bottom surface 113 of the current collector 110. The portion of the current collector corresponding to the top surface 111 and the bottom surface 113 of the current collector 110 and the body 116 can be formed integrally from a single material or block, for example.

The lid 120 can include a metallic structure to transmit electrical current to or from a battery cell, and can be disposed in contact with the current collector 110 or that can couple with the current collector 110. The lid 120 can include a top surface 121, a protrusion 122, a bottom surface 123, a wall 124, a side wall 126, and a protrusion face 128. The top surface 121 can be disposed facing away from a direction in which the protrusion 122 extends, and can contact the terminal 130. The bottom surface 123 can be disposed facing toward a direction in which the protrusion 122 extends, and can correspond to a surface of the lid 120 opposite to the top surface 121.

The protrusion 122 can include a portion of the lid 120 that extends from the bottom surface 123. The protrusion 122 can have a shape in a plan view corresponding to a shape of the opening 112, and can have a three-dimensional shape matching a shape of the opening bounded by the top surface 111, the bottom surface 113, and the wall 114. For example, the battery cell can include the protrusion having at least one of a circular shape, a square shape, and a rectangular shape that corresponds to a shape of the opening of the battery cell, the protrusion extending toward the second planar surface of the first layer and surrounded by the sloping portion. The battery cell can include the protrusion extending from a first planar surface of the lid toward the second planar surface of the current collector. The battery cell can include the lid disposed contacting the first planar surface of the current collector. Thus, the protrusion 122 can have a shape that fills the opening 112 and contacts the current collector 110 at the wall 114.

The wall 124 can include a surface of the protrusion 122, and can at least partially be surrounded by the opening 112. The wall 124 can be oriented substantially perpendicular to one or more of the top surface 121 and the bottom surface 123. The wall 124 can be oriented at an angle with one or more of the top surface 121 and the bottom surface 123, to form a slope corresponding to or matching an angle of slope of the wall 114. The wall 124 can have a height corresponding to or matching a height of the wall 114. The battery cell can include sloped surface of the protrusion having at least one of a circular, oval, polygonal, square, and rectangular shape extending from the first planar surface of the lid. The battery cell can include the protrusion disposed within the opening in the current collector between the first planar surface and the second planar surface of the current collector. The battery cell can include sloped surface of the protrusion disposed contacting the sloped surface of the wall.

The side wall 126 can include a surface of the lid raised above the top surface 121. The side wall 126 can have a surface substantially perpendicular to the top surface 121 and can have a shape in a plan view corresponding to or matching a shape of the terminal 130 in a plan view. Thus, the side wall 126 can couple the lid 120 with the terminal 130 by securing the terminal 130 to the lid 120 in any direction parallel to the top surface 121. The side wall 126 can form a notch in the lid 120 defining a depression that surrounds at least a portion of the top surface 121. The protrusion face 128 can include a planar or substantially planar surface facing a direction corresponding to the bottom surface 123. The protrusion face 128 can define an end of the protrusion 122 and a maximum extension of the protrusion 122. The protrusion face 128 can be substantially coplanar with the bottom surface 113 of the current collector 110.

The terminal 130 can include a metallic structure to transmit electrical current to or from a battery cell, and can be disposed in contact with the lid 120 or that can couple with the lid 120. The terminal 130 can include a top surface 131, a terminal face 132, a bottom surface 133, a sloping surface 134, and a lip 136. The top surface 131 can be disposed facing toward a direction in which the sloping surface 134 extends, and can contact the lid 120. The bottom surface 133 can be disposed facing away from a direction in which the sloping surface 134 extends, and can correspond to a surface of the terminal 130 opposite to the top surface 131. The battery cell can include a terminal having a second protrusion extending from a first planar surface of the terminal and disposed on the lid.

The terminal face 132 can include a portion of the top surface 131 separated from the lip 136 by the sloping surface 134. The terminal face 132 can form a top of a mesa structure or plateau structure of the terminal 130. The sloping surface 134 can form a side wall of a mesa structure or plateau structure of the terminal 130. The lip 136 can form a base of a mesa structure or plateau structure of the terminal 130. Together, the mesa structure can form a protrusion of the terminal 130 having a hollow or open space beneath the top surface of the terminal 130. The battery cell can include the second protrusion extending from the first planar surface of the terminal away from a second planar surface of the terminal opposite to the first planar surface of the terminal. The protrusion can be formed, for example, by pressing a planar material to deform the planar material into the terminal 130.

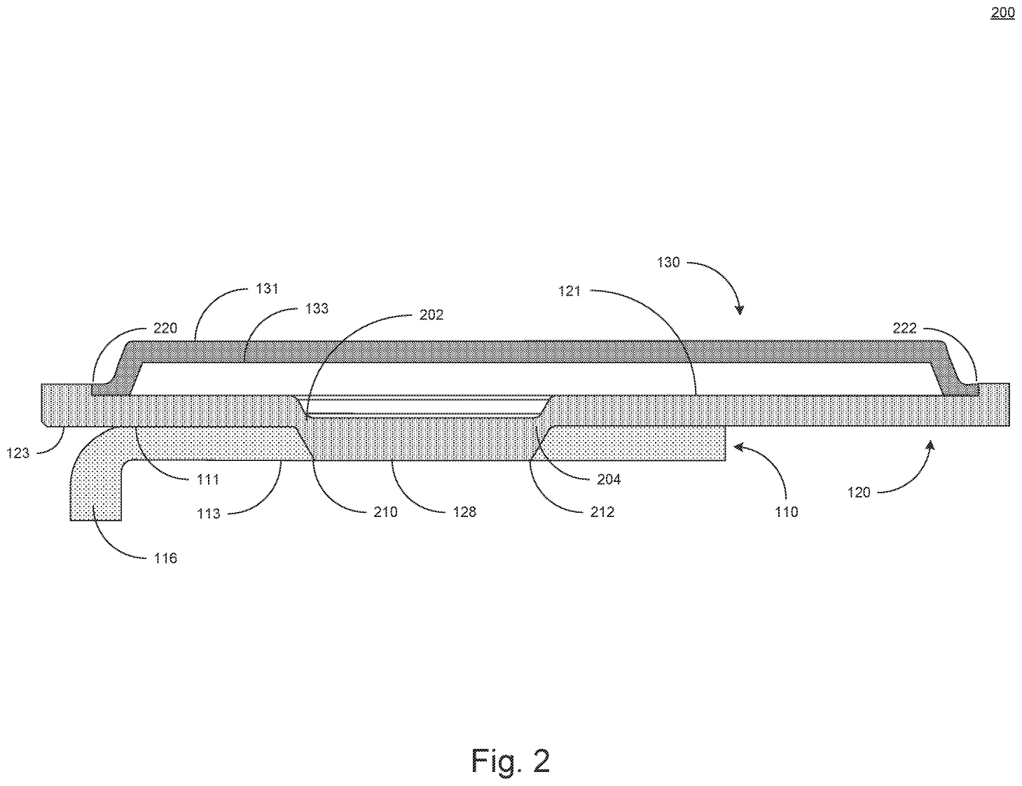

FIG. 2 depicts a cross-sectional view of a cathode terminal, in accordance with present implementations. As illustrated by way of example in FIG. 2, a view 200 can include the current collector 110, the lid 120, the terminal 130, a protrusion wall 202, a protrusion wall 204, a current collector bonding point 210, and a terminal bonding point 220. The current collector 110 can include the top surface 111, the bottom surface 113, and the body 116. The lid 120 can include the top surface 121, and the bottom surface 123. The terminal 130 can include the top surface 131, and the bottom surface 133. The current collection bonding point 210 can include a current collection bonding point 212. The terminal bonding point 220 can include a terminal bonding point 222.

The protrusion walls 202 and 204 can include an interior structure of the wall 114 or any wall as described herein, and can be disposed within or at least partially surrounded by the opening 112 or any opening as described herein. The protrusion walls 202 and 204 can have a slope corresponding to a particular angle with respect to the surfaces 111, 113, 121 and 123. For example, the protrusion walls 202 and 204 can have an angle of less than 90 degrees from a line perpendicular to at least one of the surfaces 111, 113, 121 and 123, forming a steep slope. The protrusion walls 202 and 204 can form a single structure that contacts the wall 114. The wall 114 can have a slope corresponding to a particular angle matching the slope of the protrusion walls 202 and 204.

The current collector bonding points 210 and 212 can be fused to integrate the current collector 110 with the lid 120. The current collector bonding points 210 and 212 can be fused by, any operation to bond the current collector and the lid. For example, the operation to bond can include, but is not limited to, a welding operation. The welding operation can include a laser welding operation or an arc welding operation. For example, a welding operation can include one or more welds at one or more points, along one or more arcs, or along one or more lines on a planar surface coplanar with the surfaces 113 and 128. The current collector bonding points 210 and 212 can be fused rapidly and with lower energy expenditure in welding where the opening 112 extends through the current collector, to expose the protrusion face 128. For example, the exposed protrusion face 128 can eliminate a cutting operation to expose the current collector bonding points 210 and 212. For example, the exposed protrusion face 128 can provide a visual alignment guide to any welding calibration or actuation device, reducing or eliminating time to position a welding device during manufacture.

The terminal bonding points 220 and 222 can be fused to integrate the lid 120 with the terminal 130. The terminal bonding points 220 and 222 can be fused by any bonding operation. For example, a welding operation can include a laser welding operation. For example, a welding operation can include one or more welds at one or more points, along one or more arcs, or along one or more lines on a planar surface coplanar with the a surface of the lip 136 and the surface of the lid raised above the top surface 121.

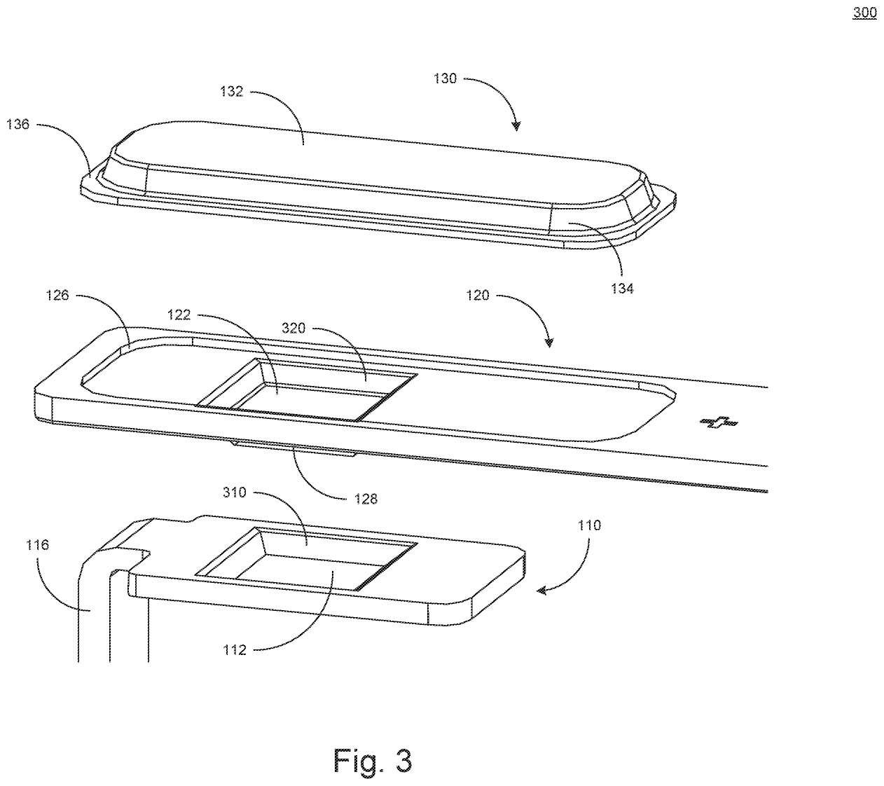

FIG. 3 depicts an example three-dimensional view of a cathode terminal 300. As illustrated by way of example in FIG. 3, an exploded view of a cathode terminal 300 can include the current collector 110, the lid 120, and the terminal 130, a polygonal wall 310, and a polygonal protrusion 320. The current collector 110 can include the opening 112, and the body 116. The lid 120 can include the protrusion 122, and the side wall 126. The terminal 130 can include the terminal face 132, the sloping surface 134, and the lip 136.

The polygonal wall 310 can include a plurality of surfaces of the current collector 110, and can at least partially surround the opening 112. The polygonal wall 310 can include a plurality of wall portions each corresponding to a side of a polygon corresponding to the shape of the polygonal wall 310 in a plan view. The polygonal wall 310 can be oriented substantially perpendicular to one or more of the top surface 111 and the bottom surface 113. The polygonal wall 310 can be oriented at an angle with one or more of the top surface 111 and the bottom surface 113, to form a slope thereof with respect to each wall portion thereof. A slope of the polygonal wall 310 can result in a portion of the opening 112 coplanar with the top surface 111 to have a size different than a portion of the opening 112 coplanar with the bottom surface 113. For example, the opening 112 can have a shape in a plan view at the top surface 111 corresponding to a square having a first side length. The opening 112 can have a shape in a plan view at the bottom surface 113 corresponding to a square having a second side length less than the first side length.

The polygonal protrusion 320 can include a portion of the lid 120 that extends from the bottom surface 123. The polygonal protrusion 320 can have a shape in a plan view corresponding to a shape of the opening 112, and can have a three-dimensional shape matching a shape of the opening bounded by the top surface 111, the bottom surface 113, and the polygonal wall 310. For example, the battery cell can include the protrusion having at least one of a circular shape, a square shape, and a rectangular shape that corresponds to a shape of the opening of the battery cell, the protrusion extending toward the second planar surface of the first layer and surrounded by the sloping portion. The battery cell can include the protrusion extending from a first planar surface of the lid toward the second planar surface of the current collector. The battery cell can include the lid disposed contacting the first planar surface of the current collector. Thus, the polygonal protrusion 320 can have a shape that fills the opening 112 and contacts the current collector 110 at the polygonal wall 310.

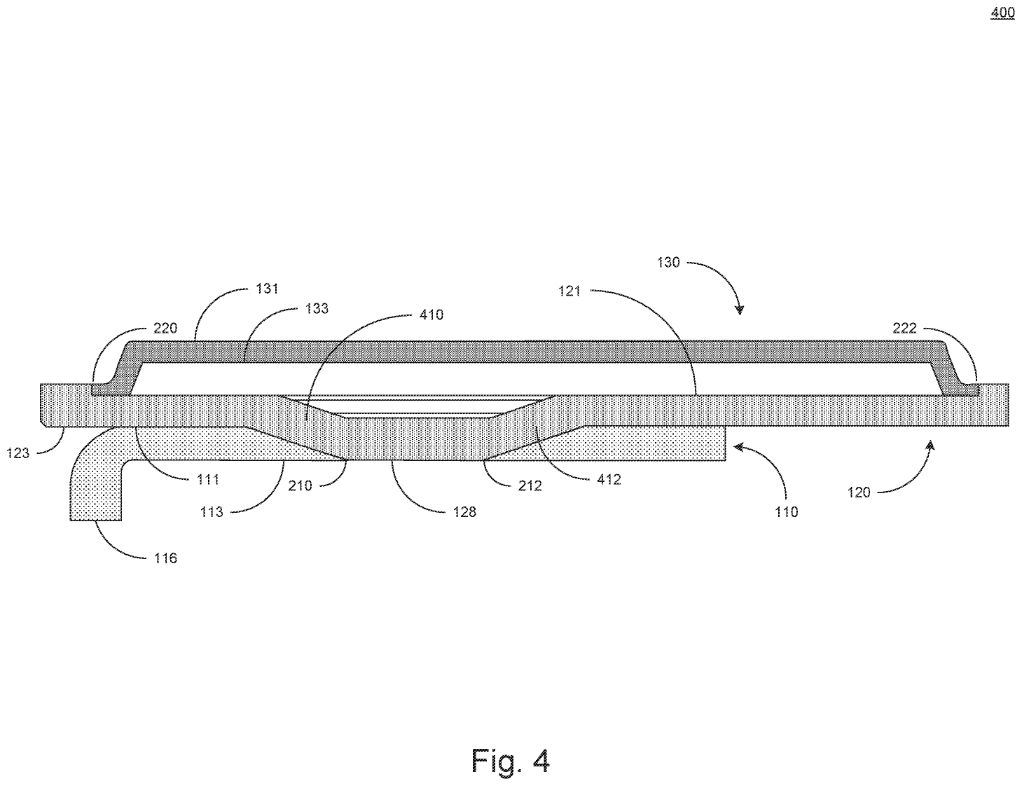

FIG. 4 depicts an example cross-sectional view of a cathode terminal 400. As illustrated by way of example in FIG. 4, a view of a cathode terminal 400 can include the current collector 110, the lid 120, and the terminal 130 the current collector bonding point 210, the terminal bonding point 220, and a protrusion wall 410. The current collector 110 can include the top surface 111, the bottom surface 113, and the body 116. The lid 120 can include the top surface 121, and the bottom surface 123. The terminal 130 can include the top surface 131, and the bottom surface 133. The current collector bonding point 210 can include the current collector bonding point 212. The terminal bonding point 220 can include the terminal bonding point 222. The protrusion wall 410 can include a protrusion wall 412.

The protrusion walls 410 and 412 can include an interior structure of the wall 114 or any wall as described herein, and can be disposed within or at least partially surrounded by the opening 112 or any opening as described herein. The protrusion walls 410 and 412 can have a slope corresponding to a particular angle with respect to the surfaces 111, 113, 121 and 123. For example, the protrusion walls 202 and 204 can have an angle of greater than 90 degrees from a line perpendicular to at least one of the surfaces 111, 113, 121 and 123, forming a shallow or gradual slope. The protrusion walls 410 and 412 can form a single structure that contacts the wall 114 or any wall as described herein. The wall 114 can have a slope corresponding to a particular angle matching the slope of the protrusion walls 410 and 412.

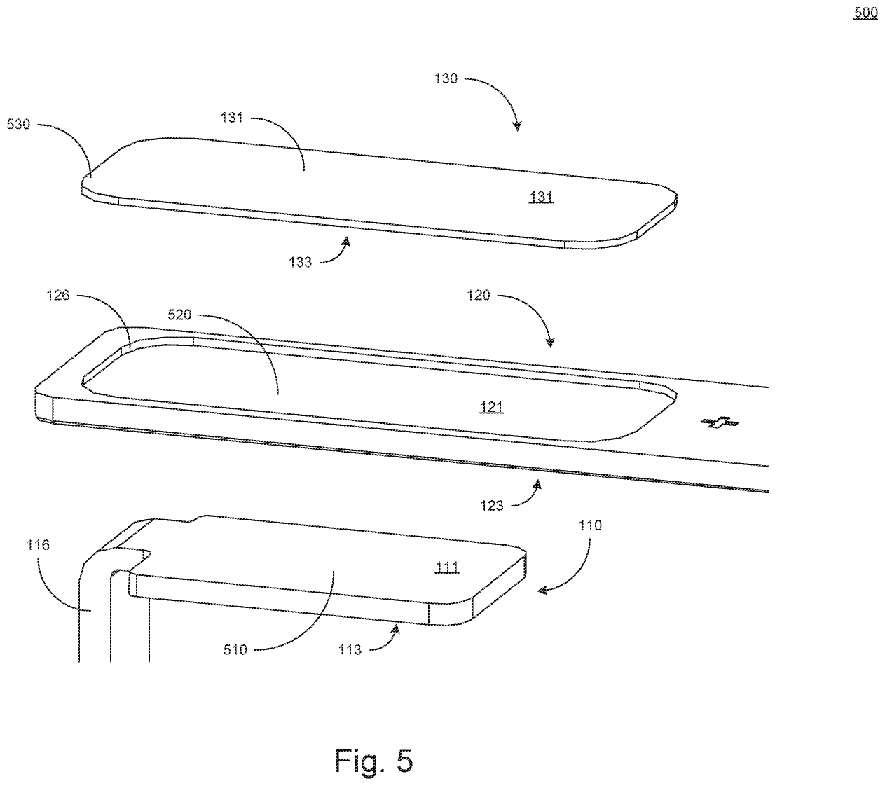

FIG. 5 depicts a three-dimensional view of a cathode terminal 500, in accordance with present implementations. As illustrated by way of example in FIG. 5, an exploded view of a cathode terminal 500 can include the current collector 110, the lid 120, the terminal 130, a current collection panel 510, a lid panel 520, and a terminal panel 530. The current collector 110 can include the top surface 111, the bottom surface 113, and the body 116. The lid 120 can include the top surface 121, and the side wall 126. The terminal 130 can include the top surface 131, and the bottom surface 133.

The current collector panel 510 can include a portion of the current collector 110 having a substantially planar surface throughout. The current collector panel 510 can be an integrated component with a solid structure throughout. The lid panel 520 can include a portion of the lid 120 having a substantially planar surface throughout. The lid panel 520 can be an integrated component with a solid structure throughout, and can couple with the current collector 110 by contact at the bottom surface 123 with the top surface 111 of the current collector 110 and the current collector panel 510. The terminal panel 530 can include a portion of the terminal 130 having a substantially planar surface throughout. The terminal panel 530 can be an integrated component with a solid structure throughout, and can couple with the lid 120 by contact at the bottom surface 133 with the top surface 121 of the lid 120 and the lid panel 520.

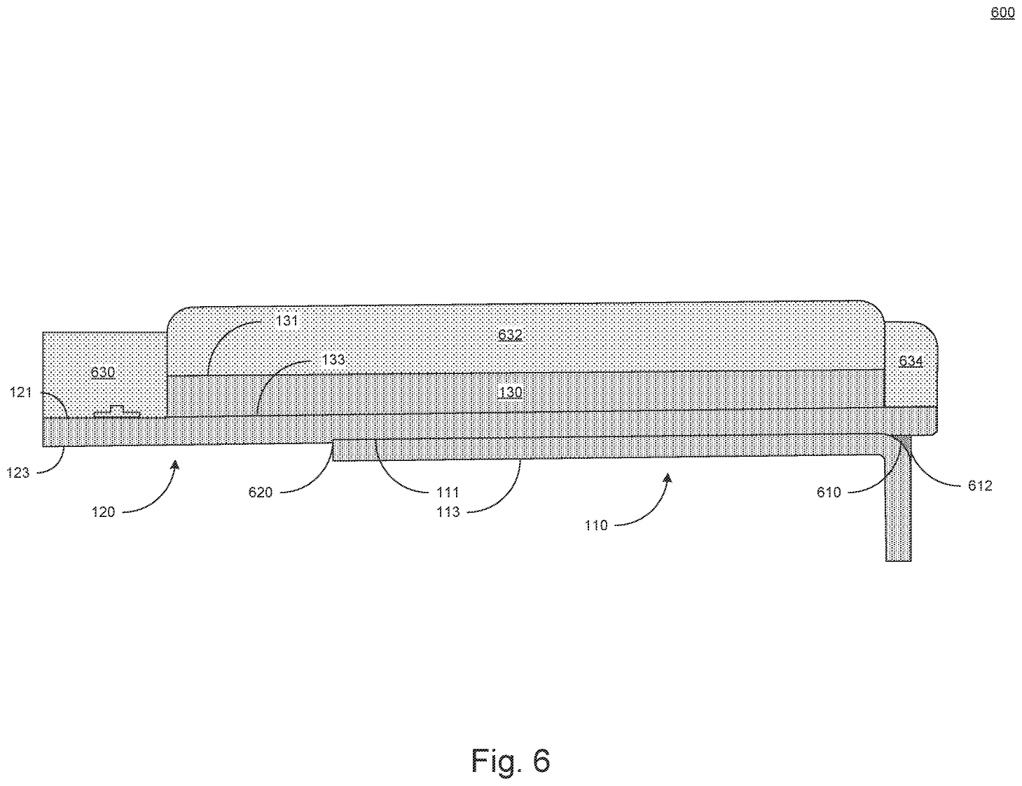

FIG. 6 depicts an example cross-sectional view of a cathode terminal 600. As illustrated by way of example in FIG. 6, a view of a cathode terminal 600 can include the current collector 110, the lid 120, the terminal 130, a coupling material 610, a coupling notch 620, and a distal lid cover 630. The current collector 110 can include the top surface 111, and the bottom surface 113. The lid 120 can include the top surface 121, and the bottom surface 123. The terminal 130 can include the top surface 131, and the bottom surface 133. The coupling material 610 can include a coupling surface 612. The distal lid cover 612 can include a terminal cover 632, and a proximal lid cover 634.

The coupling material 610 can include a bonding material within a space between the current collector 110 and the lid 120. For example, the coupling material 610 can be disposed to at least partially fill a space proximate to an end of the body 116 and the bottom surface 123 of the lid 120. The coupling material 610 can include one or more of an adhesive and a metallic bonding agent. The coupling material 610 can increase the mechanical strength of the cathode terminal by providing a bond to counteract mechanical stress at the bend of the current collector 110. The coupling surface 612 can be substantially perpendicular to the surfaces 111, 113, 121 and 123, and can be formed from an exposed portion of the coupling material 610.

The coupling notch 620 can include a portion of the bottom surface 123 of the lid 120 raised to accommodate the current collector 110. The coupling notch 620 can have a surface substantially perpendicular to the bottom surface 123 and can have a shape in a plan view corresponding to or matching a shape of the current collector 110. Thus, the coupling notch 620 can couple the current collector 110 to the lid 120 by securing the current collector 110 to the lid 120 in any direction parallel to the bottom surface 123.

The distal lid cover 630 can contact and cover at least a portion of the top surface 121 of the lid 120 exposed by the terminal 130. The terminal cover 632 can contact and cover at least a portion of the top surface 121 of the terminal 130 covering the lid 120. The proximal lid cover 634 can contact and cover at least a portion of the top surface 121 of the lid 120 exposed by the terminal 130 and proximate to the body 116 of the current collector 110. For example, one or more of the distal lid cover 630, terminal cover 632, and the proximal lid cover 634 can include a material to mitigate oxidation or change in electrical characteristics of one or more of the current collector 110 the lid 120, and the terminal 130.

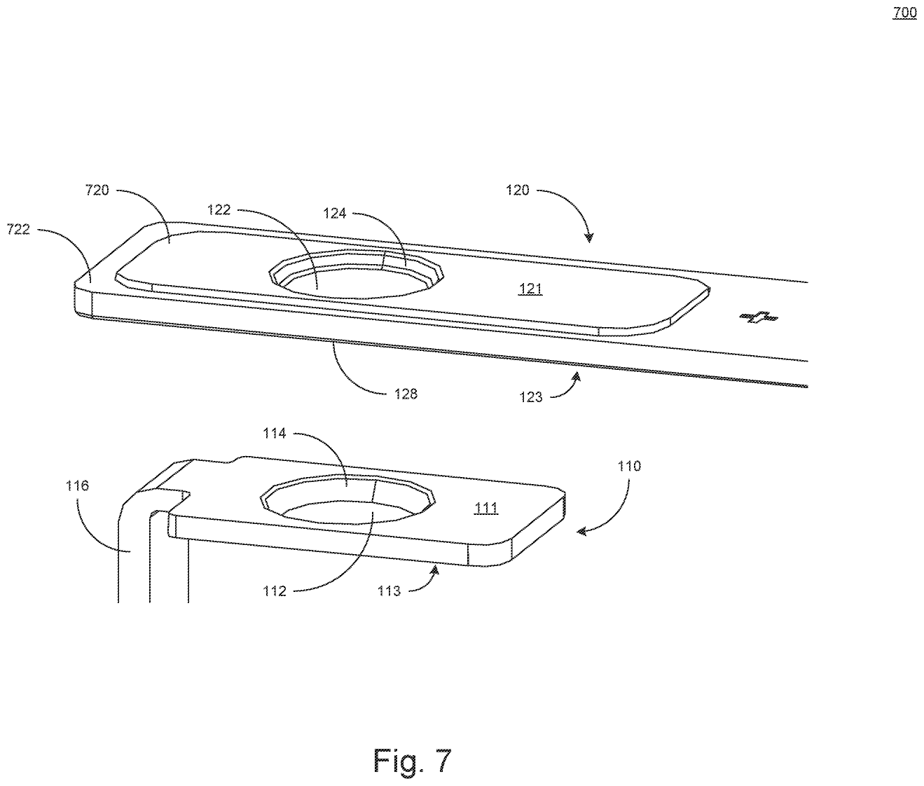

FIG. 7 depicts an example three-dimensional view of a cathode terminal 700. As illustrated by way of example in FIG. 7, an exploded view of a cathode terminal 700 can include the current collector 110, the lid 120, and the lid protrusion 720. The current collector 110 can include the top surface 111, the opening 112, the bottom surface 113, the wall 114, and the body 116. The lid 120 can include the top surface 121, the protrusion 122, the bottom surface 123, the wall 124 and the protrusion face 128.

The lid protrusion 720 can include a portion of the top surface 121 separated from a lower top surface 722 of the lid 120. The lid protrusion 720 can form a top of a mesa structure or plateau structure of the lid 120, and a side wall of a mesa structure or plateau structure of the lid 120. The lower top surface 722 can form a base of a mesa structure or plateau structure of the lid 120. Together, the mesa structure can form a protrusion of the lid 120 having a hollow or open space beneath the top surface of the lid 120. The battery cell can include the lid having a second protrusion extending away from the second planar surface of the current collector. The battery cell can include the second protrusion extending from the first planar surface of the current collector in a direction opposite to the second planar surface of the current collector. The battery cell can include the lid having a second protrusion surrounding the protrusion along the first planar surface of the current collector.

The lid protrusion 720 can be formed, for example, by pressing a planar material to deform the planar material into the lid 120, in a direction opposite to a pressing operation to form the protrusion 122. The lid protrusion 720 can reduce the amount of assembly to form a cathode terminal, by integrally forming the list protrusion in the lid 120 to eliminate welding of a terminal 130 to the lid 120. One or more of a size and shape of the lid protrusion 720 can correspond to or match a size and shape of the terminal protrusion 132.

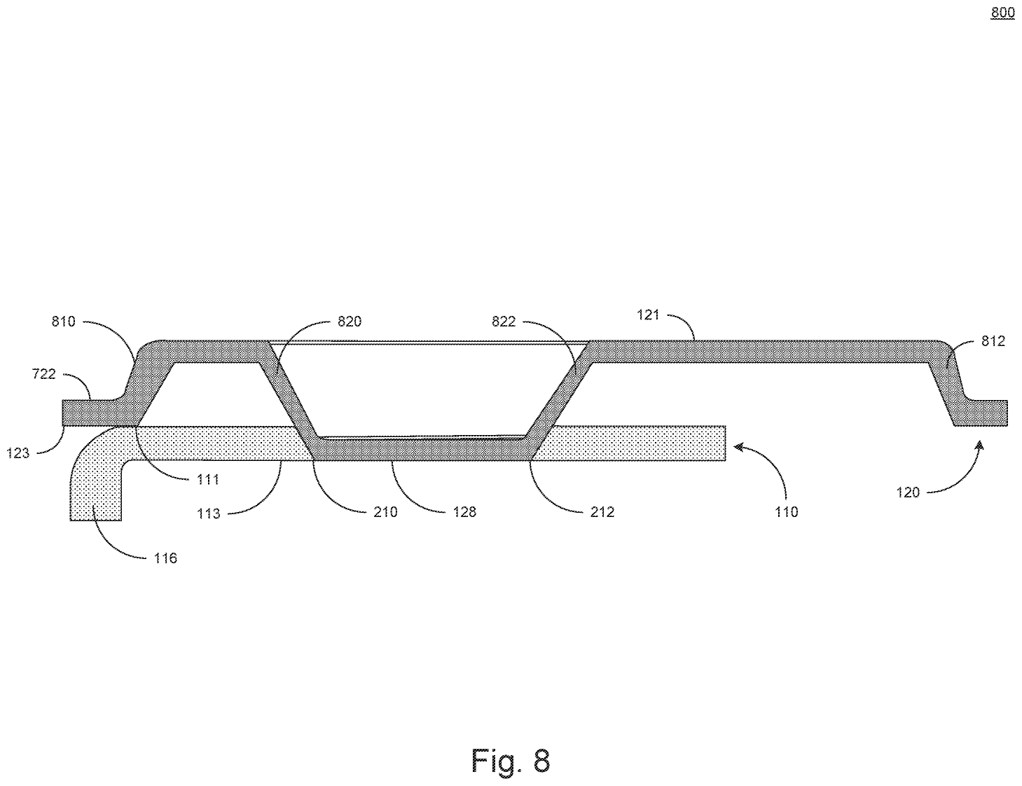

FIG. 8 depicts an example cross-sectional view of a cathode terminal 800. As illustrated by way of example in FIG. 8, a view of a cathode terminal 800 can include the current collector 110, the lid 120, the current collection bonding point 210, a lid protrusion wall 810, and a lid connection wall 820. The current collector 110 can include the top surface 111, the bottom surface 113, and the body 116. The lid 120 can include the top surface 121, the bottom surface 123, and the protrusion face 128. The current collection bonding point 210 can include the current collection bonding point 212.

The lid 120 can include a lid protrusion wall 812 and a lid connection wall 822. The lid protrusion walls 810 and 820 can include an interior structure of the lid 120, and can be disposed within or at least partially surrounding the protrusion 122. The lid protrusion walls 810 and 820 can form a single structure that is integral with and surrounds the protrusion 122 in a plan view. The lid connection walls 820 and 822 can include an interior structure of the lid 120, and can be disposed extending from the top surface 121 of the lid 120 to the bottom surface 113 of the current collection 110. The protrusion walls 410 and 412 can have a slope corresponding to a particular angle with respect to the surfaces 111, 113, 121 and 123.

FIG. 9 depicts an example cross-sectional view 900 of an electric vehicle 905 installed with at least one battery pack 910. Electric vehicles 905 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 910 can also be used as an energy storage system to power a building, such as a residential home or commercial building. Electric vehicles 905 can be fully electric or partially electric (e.g., plug-in hybrid) and further, electric vehicles 905 can be fully autonomous, partially autonomous, or unmanned. Electric vehicles 905 can also be human operated or non-autonomous. Electric vehicles 905 such as electric trucks or automobiles can include on-board battery packs 910, battery modules 915, or battery cells 920 to power the electric vehicles. The electric vehicle 905 can include a chassis 925 (e.g., a frame, internal frame, or support structure). The chassis 925 can support various components of the electric vehicle 905. The chassis 925 can span a front portion 930 (e.g., a hood or bonnet portion), a body portion 935, and a rear portion 940 (e.g., a trunk, payload, or boot portion) of the electric vehicle 905. The battery pack 910 can be installed or placed within the electric vehicle 905. For example, the battery pack 910 can be installed on the chassis 925 of the electric vehicle 905 within one or more of the front portion 930, the body portion 935, or the rear portion 940. The battery pack 910 can include or connect with at least one busbar, e.g., a current collector element. For example, the first busbar 945 and the second busbar 950 can include electrically conductive material to connect or otherwise electrically couple the battery modules 915 or the battery cells 920 with other electrical components of the electric vehicle 905 to provide electrical power to various systems or components of the electric vehicle 905.

The electric vehicle can include the battery cell. The battery cell can include a terminal having a second protrusion extending from a first planar surface of the terminal away from a second planar surface of the terminal opposite to the first planar surface of the terminal, and disposed on the lid.

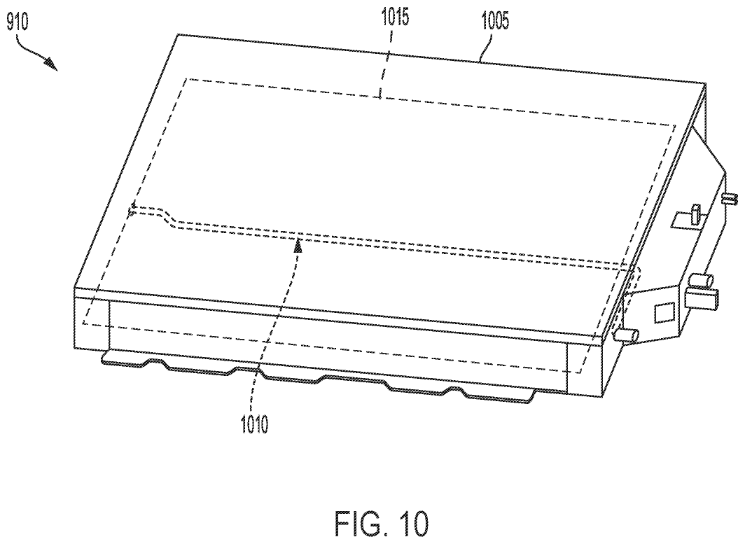

FIG. 10 depicts an example battery pack 910. Referring to FIG. 10, among others, the battery pack 910 can provide power to electric vehicle 905. Battery packs 910 can include any arrangement or network of electrical, electronic, mechanical or electromechanical devices to power a vehicle of any type, such as the electric vehicle 905. The battery pack 990 can include at least one housing 1005. The housing 1005 can include at least one battery module 915 or at least one battery cell 920, as well as other battery pack components. The housing 1005 can include a shield on the bottom or underneath the battery module 915 to protect the battery module 915 from external conditions, for example if the electric vehicle 905 is driven over rough terrains (e.g., off-road, trenches, rocks, etc.) The battery pack 910 can include at least one cooling line 1010 that can distribute fluid through the battery pack 910 as part of a thermal/temperature control or heat exchange system that can also include at least one thermal component (e.g., cold plate) 1015. The thermal component 1015 can be positioned in relation to a top submodule and a bottom submodule, such as in between the top and bottom submodules, among other possibilities. The battery pack 910 can include any number of thermal components 1015. For example, there can be one or more thermal components 1015 per battery pack 910, or per battery module 915. At least one cooling line 1010 can be coupled with, part of, or independent from the thermal component 1015.

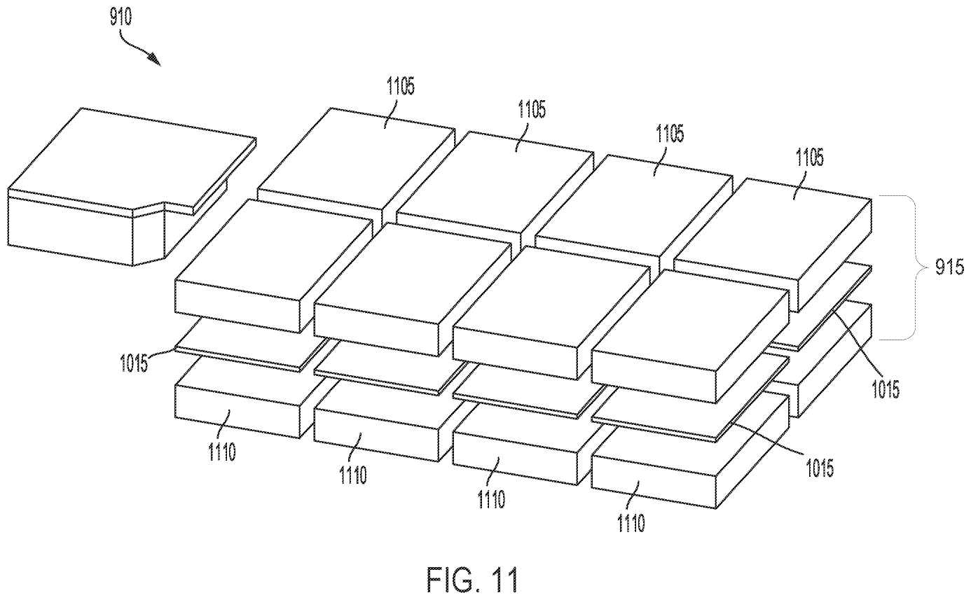

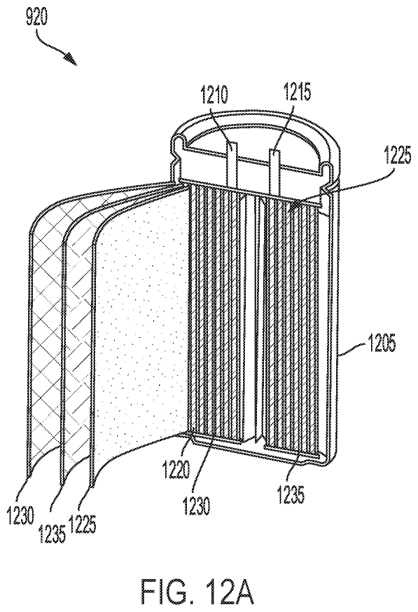

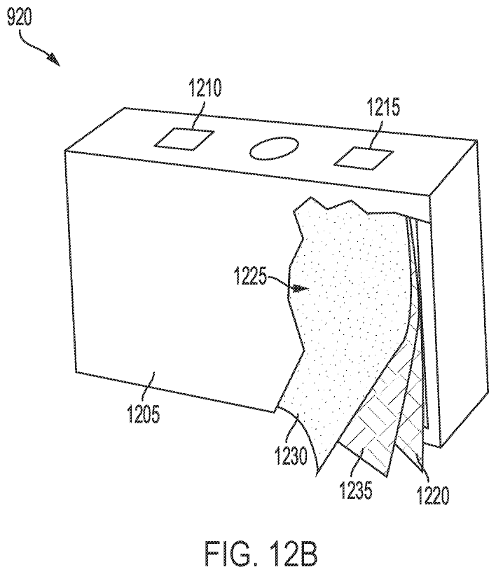

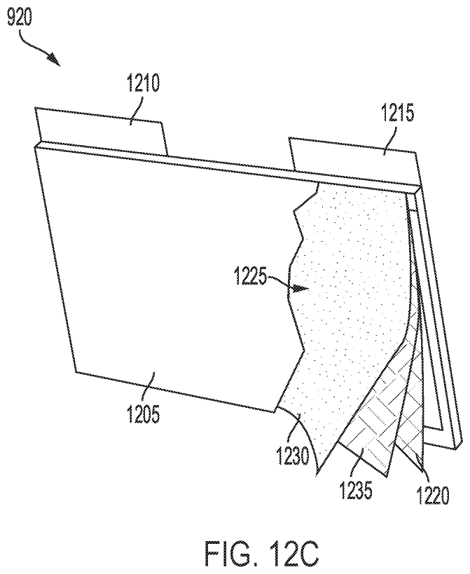

FIG. 11 depicts example battery modules 915, and FIGS. 12A, 12B and 12C depict an example cross sectional view of a battery cell 920. The battery modules 915 can include at least one submodule. For example, the battery modules 915 can include at least one first (e.g., top) submodule 1105 or at least one second (e.g., bottom) submodule 1110. At least one thermal component 1015 can be disposed between the top submodule 1105 and the bottom submodule 1110. For example, one thermal component 1015 can be configured for heat exchange with one battery module 915. The thermal component 1015 can be disposed or thermally coupled between the top submodule 1105 and the bottom submodule 1110. One thermal component 1015 can also be thermally coupled with more than one battery module 915 (or more than two submodules 1105, 1110). The thermal components 1015 shown adjacent to each other can be combined into a single thermal component 1015 that spans the size of one or more submodules 1105 or 1110. The thermal component 215 can be positioned underneath submodule 1105 and over submodule 1110, in between submodules 1105 and 1110, on one or more sides of submodules 1105, 1110, among other possibilities. The thermal component 1015 can be disposed in sidewalls, cross members, structural beams, among various other components of the battery pack, such as battery pack 910 described above. The battery submodules 1105, 1110 can collectively form one battery module 915. In some examples each submodule 1105, 1110 can be considered as a complete battery module 915, rather than a submodule.

The battery modules 915 can each include a plurality of battery cells 920. The battery modules 915 can be disposed within the housing 1005 of the battery pack 910. The battery modules 915 can include battery cells 920 that are cylindrical cells or prismatic cells, for example. The battery module 915 can operate as a modular unit of battery cells 920. For example, a battery module 915 can collect current or electrical power from the battery cells 920 that are included in the battery module 915 and can provide the current or electrical power as output from the battery pack 910. The battery pack 910 can include any number of battery modules 915. For example, the battery pack can have one, two, three, four, five, six, seven, eight, nine, ten, eleven, twelve or other number of battery modules 915 disposed in the housing 1005. It should also be noted that each battery module 915 may include a top submodule 1105 and a bottom submodule 1110, possibly with a thermal component 1015 in between the top submodule 1105 and the bottom submodule 1110. The battery pack 910 can include or define a plurality of areas for positioning of the battery module 915. The battery modules 915 can be square, rectangular, circular, triangular, symmetrical, or asymmetrical. In some examples, battery modules 915 may be different shapes, such that some battery modules 915 are rectangular but other battery modules 915 are square shaped, among other possibilities. The battery module 915 can include or define a plurality of slots, holders, or containers for a plurality of battery cells 920. It should be noted the illustrations and descriptions herein are provided for example purposes and should not be interpreted as limiting. For example, the battery cells 920 can be inserted in the battery pack 910 without battery modules 920 and 925. The battery cells 920 can be disposed in the battery pack 910 in a cell-to-pack configuration without modules 920 and 925, among other possibilities.

Battery cells 920 have a variety of form factors, shapes, or sizes. For example, battery cells 920 can have a cylindrical, rectangular, square, cubic, flat, pouch, elongated or prismatic form factor. As depicted in FIG. 12A, for example, the battery cell 920 can be cylindrical. As depicted in FIG. 12B, for example, the battery cell 920 can be prismatic. As depicted in FIG. 12C, for example, the battery cell 920 can include a pouch form factor. Battery cells 920 can be assembled, for example, by inserting a winded or stacked electrode roll (e.g., a jelly roll) including electrolyte material into at least one battery cell housing 1205. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 920 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 920. The battery cell 920 can include an electrolyte layer where the electrolyte layer can be or include solid electrolyte material that can conduct ions. For example, the solid electrolyte layer can conduct ions without receiving a separate liquid electrolyte material. Battery cells 920 can be assembled, for example, by inserting a winded or stacked electrode roll (e.g., a jelly roll) including electrolyte material into at least one battery cell housing 1205. The electrolyte material, e.g., an ionically conductive fluid or other material, can support conduction of ions between electrodes to generate or provide electric power for the battery cell 920. The housing 1205 can be of various shapes, including cylindrical or rectangular, for example. Electrical connections can be made between the electrolyte material and components of the battery cell 920. For example, electrical connections to the electrodes with at least some of the electrolyte material can be formed at two points or areas of the battery cell 920, for example to form a first polarity terminal 1210 (e.g., a positive or anode terminal) and a second polarity terminal 1215 (e.g., a negative or cathode terminal). The polarity terminals can be made from electrically conductive materials to carry electrical current from the battery cell 920 to an electrical load, such as a component or system of the electric vehicle 905.

For example, the battery cell 920 can include a lithium-ion battery cells. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 920 to separate the anode and cathode from each other and to facilitate transfer of lithium ions between the anode and cathode. It should be noted that battery cell 920 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 920 can be included in battery modules 915 or battery packs 910 to power components of the electric vehicle 905. The battery cell housing 1205 can be disposed in the battery module 915, the battery pack 910, or a battery array installed in the electric vehicle 905. The housing 1205 can be of any shape, such as cylindrical with a circular (e.g., as depicted in FIG. 12A, among others), elliptical, or ovular base, among others. The shape of the housing 1205 can also be prismatic with a polygonal base, as shown in FIG. 12B, among others. As shown in FIG. 12C, among others, the housing 1205 can include a pouch form factor. The housing 1205 can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

The housing 1205 of the battery cell 920 can include one or more materials with various electrical conductivity or thermal conductivity, or a combination thereof. The electrically conductive and thermally conductive material for the housing 1205 of the battery cell 920 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 1205 of the battery cell 920 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 1205 of the battery cell 920 is prismatic (e.g., as depicted in FIG. 12B, among others) or cylindrical (e.g., as depicted in FIG. 12A, among others), the housing 1205 can include a rigid or semi-rigid material such that the housing 1205 is rigid or semi-rigid (e.g., not easily deformed or manipulated into another shape or form factor). In examples where the housing 1205 includes a pouch form factor (e.g., as depicted in FIG. 12C, among others), the housing 1205 can include a flexible, malleable, or non-rigid material such that the housing 1205 can be bent, deformed, manipulated into another form factor or shape.

The battery cell 920 can include at least one anode layer 1220, which can be disposed within the cavity 1225 defined by the housing 1205. The anode layer 1220 can include a first redox potential. The anode layer 1220 can receive electrical current into the battery cell 920 and output electrons during the operation of the battery cell 920 (e.g., charging or discharging of the battery cell 920). The anode layer 1220 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 920 can include at least one cathode layer 1230 (e.g., a composite cathode layer compound cathode layer, a compound cathode, a composite cathode, or a cathode). The cathode layer 1230 can include a second redox potential that can be different than the first redox potential of the anode layer 1220. The cathode layer 1230 can be disposed within the cavity 1225. The cathode layer 1230 can output electrical current out from the battery cell 920 and can receive electrons during the discharging of the battery cell 920. The cathode layer 1230 can also release lithium ions during the discharging of the battery cell 920. Conversely, the cathode layer 1230 can receive electrical current into the battery cell 920 and can output electrons during the charging of the battery cell 920. The cathode layer 1230 can receive lithium ions during the charging of the battery cell 920.

The battery cell 920 can include an electrolyte layer 1235 disposed within the cavity 1225. The electrolyte layer 1235 can be arranged between the anode layer 1220 and the cathode layer 1230 to separate the anode layer 1220 and the cathode layer 1230. The electrolyte layer 1235 can transfer ions between the anode layer 1220 and the cathode layer 1230. The electrolyte layer 1235 can transfer cations from the anode layer 1220 to the cathode layer 1230 during the operation of the battery cell 920. The electrolyte layer 1235 can transfer anions (e.g., lithium ions) from the cathode layer 1230 to the anode layer 1220 during the operation of the battery cell 920.

The redox potential of layers (e.g., the first redox potential of the anode layer 1220 or the second redox potential of the cathode layer 1230) can vary based on a chemistry of the respective layer or a chemistry of the battery cell 920. For example, lithium-ion batteries can include an LFP (lithium iron phosphate) chemistry, an NMC (Nickel Manganese Cobalt) chemistry, an NCA (Nickel Cobalt Aluminum) chemistry, or an LCO (lithium cobalt oxide) chemistry for a cathode layer (e.g., the cathode layer 1230). Lithium-ion batteries can include a graphite chemistry, a silicon-graphite chemistry, or a lithium metal chemistry for the anode layer (e.g., the anode layer 1220). For example, a cathode layer having an LFP chemistry can have a redox potential of 3.45V, while an anode layer having a graphite chemistry can have a 0.25V redox potential.

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example Lithium iron phosphate (LFP), Lithium iron manganese phosphate (LMFP), a layered oxides (LiMO₂, M=Ni and/or Co and/or Mn and/or Fe and/or Al and/or Mg) examples NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, other additives as a coating on a current collector (metal foil). The chemical composition of the electrode layers can affect the redox potential of the electrode layers. For example, cathode layers (e.g., the cathode layer 1230) can include high-nickel content (>80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer 1220) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 1235 can include or be made of a liquid electrolyte material. For example, the electrolyte layer 1235 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 1235 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO3 (A=Li, Ca, Sr, La, and B=Al, Ti), garnet-type with formula A3B2(XO4)3 (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li3PS4, Li7P3S11, Li2S—P2S5, Li2S—B2S3, SnS—P2S5, Li2S—SiS2, Li2S—P2S5, Li2S—GeS2, Li10GeP2S12) and/or sulfide-based lithium argyrodites with formula Li6PS5X (X=Cl, Br) like Li6PS5Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 1235 includes a liquid electrolyte material, the electrolyte layer 1235 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 1235 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 1235 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 1235 from greater than 0 M to about 1.5 M.

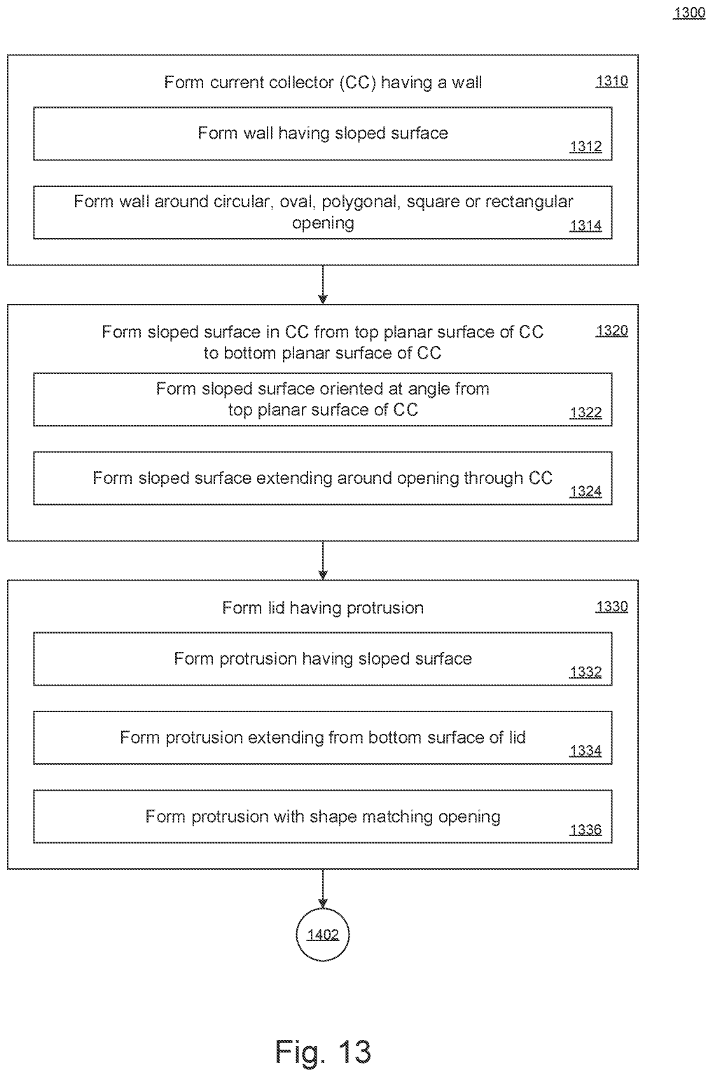

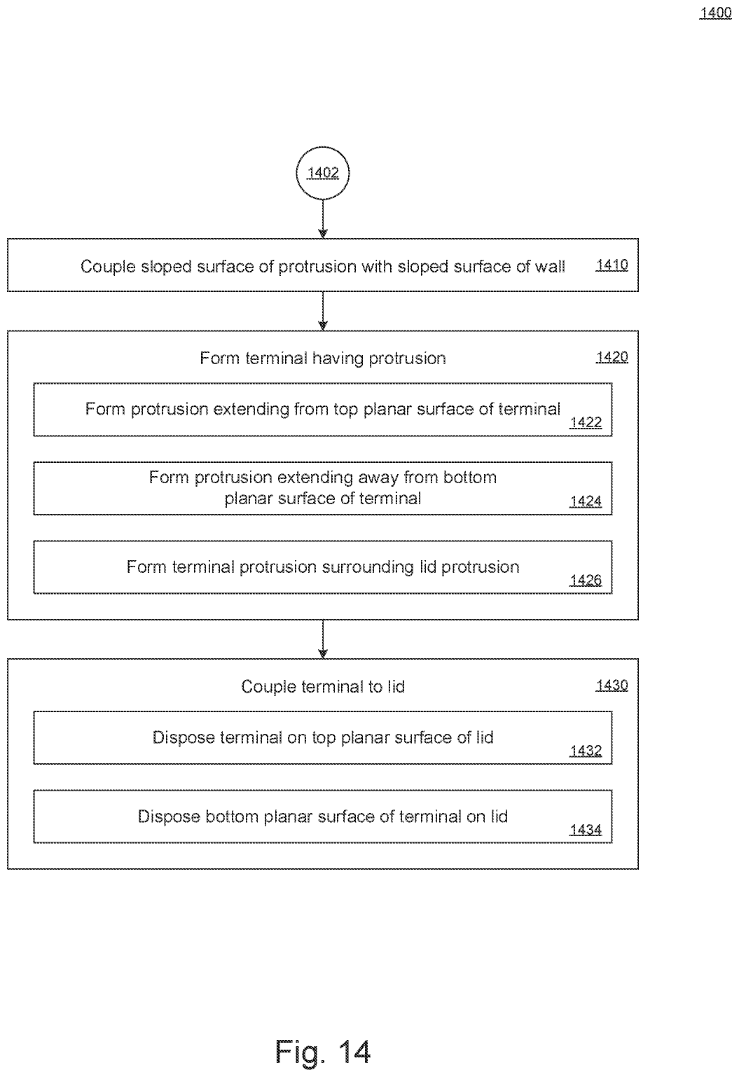

FIGS. 13-14 depict an example method illustrated by 1300 and 1400. The method can include the sloped surface of the wall oriented at an angle from the first planar surface of the current collector and extending around an opening in the current collector between the first planar surface and the second planar surface of the current collector, the opening projecting at least one of a circular, oval, polygonal, square, and rectangular shape from the first planar surface of the current collector. The method can include the protrusion having at least one of the circular, square, and rectangular shape corresponding to the at least one of the circular, oval, polygonal, square, and rectangular shapes of the opening. The method can include forming a terminal having a second protrusion extending from a first planar surface of the terminal away from a second planar surface of the terminal opposite to the first planar surface of the terminal, and disposed on the lid. The method can include the lid having a second protrusion extending from the first planar surface of the current collector in a direction opposite to the second planar surface of the current collector, and surrounding the protrusion along the first planar surface of the current collector.

FIG. 13 depicts a method 1300 of battery cell cathode terminal with integrable protrusion structures. The method 1300 can form one or more of the views of the cathode terminal 100-800.

The method 1300 can include forming a current collector having a wall. (Act 1310.) For example, a current collector 110 can be formed having a wall 114 that forms an edge of an opening 112 within or through the current collector 110. Forming a current collector 110 having a wall 114 can include forming a current collector 100 having a wall 114 with a sloped surface. (Act 1312.) For example, a current collector 110 can be formed having a sloping wall of a particular angle with respect to a planar surface of the current collector 110. Forming a current collector 110 having a wall 114 can include forming a wall 114 around circular, oval, polygonal, square or rectangular opening 112. (Act 1314.) For example, the opening 112 can be cut or pressed into a planar surface 111 of the current collector 110 by a die having a particular two-dimensional shape in a plan view.

The method 1300 can include forming a sloped surface in a current collector 110 from a top planar surface 111 of a current collector 110 to a bottom planar surface 113 of a current collector 110. (Act 1320.) For example, the sloped surface can be formed as part of a cutting or pressing process by a die having a particular two-dimensional shape. For example, forming a sloped surface in a current collector 110 from a top planar surface 111 of a current collector 110 to a bottom planar surface 113 of a current collector 110 can occur subsequent to forming a current collector 110 having a wall 114. Forming a sloped surface in a current collector 110 from a top planar surface 111 of a current collector 110 to a bottom planar surface 113 of a current collector 110 can include forming a sloped surface oriented at angle from a top planar surface 111 of a current collector 110. (Act 1322.) For example, a sloped surface can be formed by a laser cut or cutting operation with a cutting surface or a laser oriented at a particular angle with respect to a planar surface of the current collector 110. Forming a sloped surface in a current collector 110 from a top planar surface 111 of a current collector 110 to a bottom planar surface of a current collector 110 can include forming a sloped surface extending around an opening 112 through a current collector 110. (Act 1324.) For example, the sloped surface can be formed around an opening 112 where a cut is performed to remove a portion of the current collector 110 through a depth dimension of the current collector 110.

The method 1300 can include forming a lid 120 having a protrusion 122. (Act 1330.) For example, a protrusion 122 can be formed into the lid 120 by a pressing operation by a die having a particular two-dimensional shape in a plan view. For example, forming a lid 120 having a protrusion 122 can occur subsequent to forming a sloped surface in a current collector 110 from a top planar surface 111 of a current collector 110 to a bottom planar surface 113 of a current collector 110. Forming a lid 120 having a protrusion 122 can include forming a protrusion 122 having a sloped surface. (Act 1332.) For example, the sloped surface can be formed by a die having a sloped surface corresponding to or matching the sloped surface of the protrusion 122. Forming a lid 120 having a protrusion can include forming a protrusion 122 extending from a bottom surface 123 of a lid 120. (Act 1334.) Forming a lid 120 having a protrusion 122 can include forming a protrusion 122 with a shape matching an opening 112 of the current collector 110. (Act 1336.) For example, both the protrusion 122 and the opening 112 can be formed by dies having corresponding or matching two-dimensional shapes in a plan view.

FIG. 14 depicts a method 1400 of battery cell cathode terminal with integrable protrusion structures. The method 1400 can form one or more of the cathode terminals 100-800. The method 1400 can include coupling a sloped surface of a protrusion 122 of the lid 120 with a sloped surface of a wall 114 of the current collector 110. (Act 1402, 1410.) For example, the current collector 110 and the lid 120 can be placed adjacent to or abutting each other with the protrusion 122 of the lid 120 fitting into the opening 112 of the current collector 110, and the current collector 110 and the lid 120 aligned in a length direction corresponding to a longest side of the lid 120 and the current collector 110, respectively. For example, coupling a sloped surface of a protrusion 122 of the lid 120 with a sloped surface of a wall 114 of the current collector 110 can occur subsequent to forming a lid 120 having a protrusion 122.

The method 1400 can include forming a terminal 130 having a protrusion 132. (Act 1420.) For example, a protrusion 132 having a mesa structure can be formed in the terminal 130 by a pressing operation with a die having a two-dimensional shape in a plan view corresponding to or matching a top surface 131 of the mesa structure of the terminal 130. For example, forming a terminal 130 having a protrusion 132 can occur subsequent to coupling a sloped surface of a protrusion 122 of the lid 120 with a sloped surface of a wall 114 of the current collector 110. Forming a terminal 130 having a protrusion 132 can include forming a terminal 130 having a protrusion 132 extending from a top planar surface 131 of a terminal 130. (Act 1422.) Forming a terminal 130 having a protrusion 132 can include forming a terminal 130 having a protrusion 132 extending away from bottom planar surface 133 of terminal 130. (Act 1424.) Forming a terminal 130 having a protrusion 132 can include forming a terminal 130 having a protrusion 132 surrounding a lid protrusion 122. (Act 1426.) For example, the protrusion 132 of the terminal 130 can be formed by a die having a two-dimensional shape in a plan view that is larger than and contains a two-dimensional shape in a plan view of the lid protrusion 122.

The method 1400 can include coupling a terminal 130 to a lid 120. (Act 1430.) For example, a lid 120 and a terminal 130 can be placed adjacent to or abutting each other with the lip 136 of the terminal 130 fitting into the side wall 126 of the lid 120, and the lid 120 and the terminal 130 aligned in a length direction corresponding to a longest side of the lid 120 and the terminal 130, respectively. For example, coupling a terminal 130 to a lid 120 can occur subsequent to forming a terminal 130 having a protrusion 122. Coupling a terminal 130 to a lid 120 can include disposing a terminal 130 on a top planar surface 121 of a lid 120. (Act 1432.) Coupling a terminal 130 to a lid 120 can include disposing a bottom planar surface 133 of a terminal 130 on a lid 120. (Act 1434.)

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A battery cell, comprising:
a current collector having a wall that defines an opening, the wall having a surface from a first planar surface of the current collector to a second planar surface of the current collector;
a lid having a side wall and a protrusion, the protrusion integrally formed as a single piece with the lid, the protrusion having a protrusion wall and a protrusion face integrally formed as a single piece with the protrusion wall, and the surface of the protrusion coupled with the surface of the wall, the current collector integrated with the lid by a welding at one or more first bonding points, the side wall pressed into the lid; and
a terminal having a second protrusion extending from a first planar surface of the terminal and disposed on the lid, the terminal integrated with the lid by the welding at one or more second bonding points at the side wall, the surface of the terminal coplanar with the surface of the lid at the side wall.

2. The battery cell of claim 1, comprising:
the surface of the wall comprising a sloped surface and oriented at an angle from the first planar surface of the current collector and extending around the opening in the current collector between the first planar surface and the second planar surface of the current collector.

3. The battery cell of claim 1, comprising:
the wall comprising a sloped surface and defining the opening that projects at least one of a circular, oval, polygonal, square, and rectangular shape from the first planar surface of the current collector.

4. The battery cell of claim 1, comprising:
the protrusion having a sloped surface and at least one of a circular shape, a square shape, and a rectangular shape that corresponds to a shape of the opening of the battery cell, the protrusion extending toward the second planar surface.

5. The battery cell of claim 1, comprising:
the surface of the protrusion comprising a sloped surface and having at least one of a circular, oval, polygonal, square, and rectangular shape extending from the first planar surface of the lid.

6. The battery cell of claim 1, comprising:
the protrusion disposed within the opening in the current collector between the first planar surface and the second planar surface of the current collector.

7. The battery cell of claim 1, comprising:
sloped surface of the protrusion disposed contacting the sloped surface of the wall.

8. (canceled)

9. The battery cell of claim 1, comprising:
the second protrusion extending from the first planar surface of the terminal away from a second planar surface of the terminal opposite to the first planar surface of the terminal.

10. The battery cell of claim 1, comprising:
the protrusion extending from a first planar surface of the lid toward the second planar surface of the current collector.

11. The battery cell of claim 1, comprising:
the lid disposed contacting the first planar surface of the current collector.

12. The battery cell of claim 1, comprising:
the lid having the second protrusion extending away from the second planar surface of the current collector.

13. The battery cell of claim 12, comprising:
the second protrusion extending from the first planar surface of the current collector in a direction opposite to the second planar surface of the current collector.

14. The battery cell of claim 1, comprising:
the lid having a second protrusion surrounding the protrusion along the first planar surface of the current collector.

15. A method, comprising:
forming a current collector having a wall; and
forming a lid integrally as a single piece with a protrusion, the protrusion having a protrusion wall and a protrusion face, the protrusion coupled with the surface of the wall;
pressing a side wall into the lid;
integrating the current collector with the lid by a welding at one or more first bonding points;
integrating a terminal with the lid by the welding at one or more second bonding points at the side wall, the terminal having a second protrusion extending from a first planar surface of the terminal and disposed on the lid, the surface of the terminal coplanar with the surface of the lid at the side wall.

16. The method of claim 15, comprising:
the wall having a surface comprising a sloped surface and oriented at an angle from the first planar surface of the current collector and extending around an opening in the current collector between a first planar surface of the current collector and a second planar surface of the current collector, the opening projecting at least one of a circular, oval, polygonal, square, and rectangular shape from the first planar surface of the current collector; and
the protrusion having a sloped surface and at least one of the circular, square, and rectangular shape corresponding to the at least one of the circular, oval, polygonal, square, and rectangular shapes of the opening.

17. The method of claim 15, comprising:
forming the terminal having a second protrusion extending from a first planar surface of the terminal away from a second planar surface of the terminal opposite to the first planar surface of the terminal.

18. The method of claim 15, comprising:
the lid having the second protrusion extending from a first planar surface of the current collector in a direction opposite to a second planar surface of the current collector, and surrounding the protrusion along the first planar surface of the current collector.

19. An electric vehicle, comprising:
a battery cell, comprising:
a current collector having a wall, the wall having a surface from a first planar surface of the current collector to a second planar surface of the current collector;
a lid having a side wall and a protrusion, the protrusion integrally formed as a single piece with the lid, the protrusion having a protrusion wall and a protrusion face integrally formed as a single piece with the protrusion wall, and the surface of the protrusion coupled with the surface of the wall, the current collector integrated with the lid by a welding at one or more first bonding points, the side wall pressed into the lid; and
a terminal having a second protrusion extending from a first planar surface of the terminal and disposed on the lid, the terminal integrated with the lid by the welding at one or more second bonding points at the side wall, the surface of the terminal coplanar with the surface of the lid at the side wall.

20. The electric vehicle of claim 19, comprising:
the battery cell comprising:
the terminal having the second protrusion extending from a first planar surface of the terminal away from a second planar surface of the terminal opposite to the first planar surface of the terminal, and disposed on the lid.
